(19) United States
(12) Patent Application Publication
(10) Pub. No.: US 2026/0134424 A1
(43) Pub. Date: May 14, 2026

(54) USER VERIFICATION SYSTEM AND METHOD

(71) Applicant: Visa International Service Association, San Francisco, CA (US)

(72) Inventors: Jalpesh Chitalia, Belmont, CA (US); Gavin Shenker, Los Angeles, CA (US)

(73) Assignee: Visa International Service Association, San Francisco, CA (US)

(21) Appl. No.: 19/118,103

(22) PCT Filed: Oct. 4, 2023
(86) PCT No.: PCT/US2023/075941

§ 371 Date: Apr. 3, 2025

Related U.S. Application Data
(60) Provisional application No. 63/413,341, filed on Oct. 5, 2022.

(51) Int. Cl. G06Q 20/38; G06Q 20/12; G06Q 20/16; G06Q 20/32; G06Q 20/40; H04L 9/32

(52) U.S. Cl. CPC G06Q 20/385; G06F 21/42; G06Q 20/12; G06Q 20/3226; G06Q 20/401; H04L 9/3228; G06Q 20/16; H04L 9/0827; H04L 2209/56

(57) ABSTRACT

A method is disclosed. The method includes receiving, from a client device, a checkout request for a transaction between a user operating the client device and a resource provider operating the resource provider computer. The resource provider computer and the client device communicate via a first communication channel. The method includes obtaining a first one-time code, displaying, the first one-time code to the user on the client device, and determining an indication that the first one-time code matches a second one-time code that was provided by the user through a second communication channel that is different than the first communication channel. The method includes allowing the transaction to continue based on the determination that the first one-time code matches the second one-time code.

### CROSS-REFERENCES TO RELATED APPLICATIONS

This application is a PCT application, which claims priority U.S. Provisional Application No. 63/413,341, filed on Oct. 5, 2022, which is herein incorporated by reference in its entirety for all purposes.

### BACKGROUND

Two factor authentication processes using one-time passcodes are used to provide data security in payment transactions. A conventional two-factor authentication process can include a server computer transmitting a one-time password to a mobile phone of the user when the user is attempting to conduct a transaction such as a purchase transaction on an application or Website. The user can then enter the one-time password into the application or Website to authenticate the user. The assumption is that only the authorized user is in possession of the mobile phone which is known to the server computer.

Although two-factor authentication processes are effective, improvements can be made. One problem is that fraud attacks via social engineering can be used to steal one-time passwords from authorized users. For example, an unauthorized user can obtain an authorized user's personal information (e.g., credit card number, phone number, email, etc.) through illegitimate means (e.g., the dark Web). The unauthorized person can use the authorized user's personal information to convince the authorized user to share a one-time code with them by using that personal information. For example, the unauthorized user can fraudulently tell the authorized user that their account has been hacked and that they need the one-time code that is being sent to them to verify their identity. The unauthorized user can then use the one-time code to perform an unauthorized transaction.

Embodiments of the disclosure address this problem and other problems individually and collectively.

### SUMMARY

One embodiment of the invention includes a method. The method comprises receiving, by a resource provider computer from a client device, a checkout request for a transaction between a user operating the client device and a resource provider operating the resource provider computer, the resource provider computer and the client device communicating via a first communication channel; obtaining, by the resource provider computer, a first one-time code; displaying, by the resource provider computer, the first one-time code to the user on the client device; determining, by the resource provider computer, an indication that the first one-time code matches a second one-time code that was provided by the user through a second communication channel that is different than the first communication channel; and allowing, by the resource provider computer, the transaction to continue based on the determination that the first one-time code matches the second one-time code.

Another embodiment of the invention includes a resource provider computer comprising: a processor; and a non-transitory computer readable medium, the non-transitory computer readable medium comprising code, executable by the processor for implementing a method comprising: receiving, from a client device, a checkout request for a transaction between a user operating the client device and a resource provider operating the resource provider computer, the resource provider computer and the client device communicating via a first communication channel; obtaining a first one-time code; displaying the first one-time code to the user on the client device; determining an indication that the first one-time code matches a second one-time code that was provided by the user through a second communication channel that is different than the first communication channel; and allowing the transaction to continue based on the determination that the first one-time code matches the second one-time code.

Another embodiment of the invention includes a method comprising: receiving, by an authentication server computer from a resource provider computer, a request for a one-time code, after the resource provider computer receives from a client device, a checkout request for a transaction between a user operating the client device and a resource provider operating the resource provider computer, the resource provider computer and the client device communicating via a first communication channel; generating, by the authentication server computer, a first one-time code; transmitting, by the authentication server computer, the first one-time code to the client device; receiving, by the authentication server computer, a second one-time code from a mobile device via a second communication channel; comparing, by the authentication server computer, the first one-time code to the second one-time code; and transmitting, by the authentication server computer to the resource provider computer, an indication that the first one-time code and the second one-time code match, wherein the resource provider computer thereafter allows the transaction to proceed.

Another embodiment of the invention includes an authentication server computer comprising: a processor; and a computer readable medium coupled to the processor. The computer readable medium comprises code, executable by the processor to perform a method comprising: receiving, by an authentication server computer from a resource provider computer, a request for a one-time code, after the resource provider computer receives from a client device, a checkout request for a transaction between a user operating the client device and a resource provider operating the resource provider computer, the resource provider computer and the client device communicating via a first communication channel; generating, by the authentication server computer, a first one-time code; transmitting, by the authentication server computer, the first one-time code to the client device; receiving, by the authentication server computer, a second one-time code from the client device or a mobile device; comparing, by the authentication server computer, the first one-time code to the second one-time code; and transmitting, by the authentication server computer to the resource provider computer, an indication that the first one-time code and the second one-time code match, wherein the resource provider computer thereafter allows the transaction to proceed.

A better understanding of the nature and advantages of embodiments of the invention may be gained with reference to the following detailed description and accompanying drawings.

### BRIEF DESCRIPTION OF THE DRAWINGS

FIG. 1 shows a block diagram of a system according to an embodiment.

FIG. 2A shows a flow diagram of a resource provider verifying a user for a payment transaction according to embodiments.

FIG. 2B shows a flow diagram of a resource provider processing a transaction according to embodiments.

FIG. 3 shows a block diagram of a communication device according to embodiments.

FIG. 4 shows a block diagram of a resource provider computer according to embodiments.

FIG. 5 shows a block diagram of an authentication server computer according to embodiments.

FIG. 6 shows example screens of a client device during a verification of a transaction according to embodiments.

FIG. 7 shows an example screen on a mobile device in which a user can enter a one-time code.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “client device” may be a device that interacts with a server computer. Client devices may be in any suitable form. Some examples of client devices include laptop computers, cellular phones, PDAs, personal computers (PCs), tablet computers, and the like. In some embodiments, where a client device is a mobile device, the mobile device may include a display, a memory, a processor, a computer-readable medium, and any other suitable component.

A “mobile device” (sometimes referred to as a mobile communication device) may comprise any suitable electronic device that may be transported and operated by a user, which may also provide remote communication capabilities to a network. A mobile communication device may communicate using a mobile phone (wireless) network, wireless data network (e.g., 3G, 4G or similar networks), Wi-Fi, Bluetooth, Bluetooth Low Energy (BLE), Wi-Max, or any other communication medium that may provide access to a network such as the Internet or a private network. Examples of mobile devices include mobile phones (e.g., cellular phones), PDAs, tablet computers, net books, laptop computers, wearable devices (e.g., watches), vehicles such as automobiles and motorcycles, personal music players, hand-held specialized readers, etc. A mobile device may comprise any suitable hardware and software for performing such functions, and may also include multiple devices or components (e.g., when a device has remote access to a network by tethering to another device—i.e., using the other device as a modem—both devices taken together may be considered a single mobile device).

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes, and other login information, etc.

“Payment credentials” may include any suitable information associated with an account (e.g., a payment account and/or payment device associated with the account). Such information may be directly related to the account or may be derived from information related to the account. Examples of account information may include a PAN (primary account number or “account number”), username, expiration date, and verification values such as CVV, dCVV, CVV2, dCVV2, and CVC3 values.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Embodiments can provide for improved methods and systems to authenticate users in transactions. In embodiments of the invention, a resource provider computer can receive from a client device, a checkout request for a transaction between a user operating the client device and a resource provider operating the resource provider computer. The checkout request can be associated with a payment for goods or services to be purchased by the user on a resource provider Website or application. The resource provider computer and the client device can communicate via a first communication channel.

The resource provider computer obtains a first one-time code from an authentication server computer which stores an address or other contact information of a mobile device that is used by the user. In embodiments of the invention, the resource provider computer can obtain information such as the user's contact information or the user's credential (e.g., a primary account number) and can send it to the authentication server computer.

The authentication server computer can then generate the first one-time code and send it to the resource provider computer, which provides (e.g., displays) the first one-time code to the user via the client device. The user then enters the same one-time code into an application on the user's mobile device. The one-time code that is entered into the user's mobile device can be characterized as a second one-time code. The user can then enter the second one-time code into an application on the user's mobile device, and the mobile device then transmits the second one-time code to the authentication server computer via a second communication channel. The second communication channel is different from the first communication channel. The authentication server computer then compares the second one-time code received from the mobile device with the first one-time code that was generated and sent to the resource provider computer. If they match, then the authentication server computer generates an indication of the match and sends it to the resource provider computer.

The resource provider computer determines the indication by analyzing the received indication of the match, and then allows the transaction to continue based on the determination that the one-time codes match.

Embodiments of the invention have a number of technical advantages. As noted above, in embodiments of the invention, the verification may involve a server computer (e.g., issuer bank) sending a one-time code to a resource provider computer (e.g., merchant) instead of sending the one-time code directly to a mobile device (e.g., phone) of the user. By doing so, an unauthorized person cannot steal an authorized user's one-time code using social engineering and use it to conduct unauthorized transactions. If the unauthorized person attempts to conduct a transaction such as a payment transaction on a merchant application or Website by impersonating the authorized user, a fraudster cannot steal the one-time code and use it to conduct a transaction, since the one-time code is shown to the person attempting to conduct the transaction and the authorized user is not in possession of the one-time code.

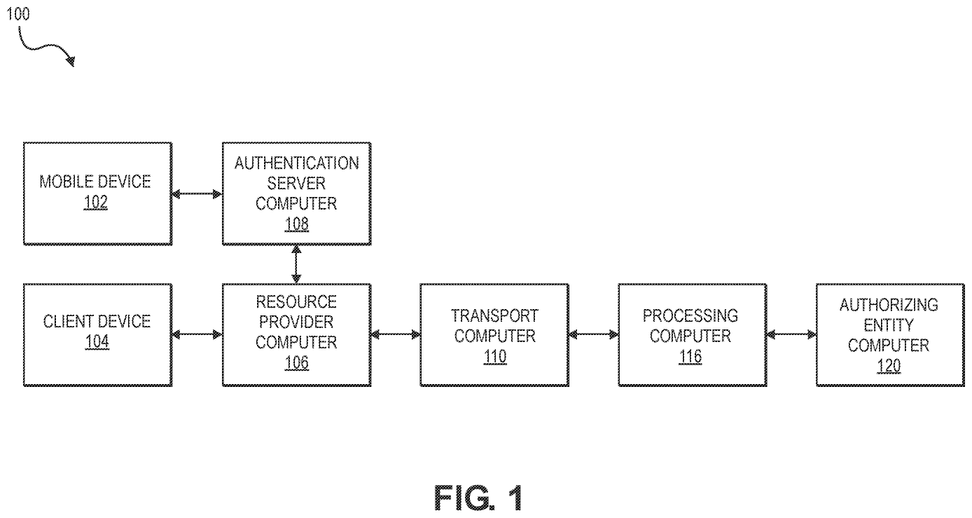

FIG. 1 shows a system comprising a mobile device 102 and a client device 104, which are separate devices and may be operated by a user. In one example, the mobile device 102 can be a mobile phone operated by the user and the client device 104 can be a laptop computer operated by the user. In another example, the mobile device 102 can be a smartwatch and the client device 104 can be a mobile phone. In yet other embodiments, the client device 104 can be laptop computer and the mobile device 102 can be a component within the laptop computer.

The mobile device 102 can be in communication with an authentication server computer 108. The authentication server computer 108 and the client device 104, can be in communication with a resource provider computer 106. The resource provider computer 106 can be in communication with an authorizing entity computer 120 via a transport computer 110 and a processing computer 116.

The authentication server computer 108 can perform authentication processes such as the generation and transmission of one-time use codes, and the validation of received one-time use codes. In some embodiments, the user can register the contact information (e.g., an address such as a phone number or network address) of the mobile device 102 with the authentication server computer 108. The contact information may be stored in conjunction with other information of the user such as a credential (e.g., a primary account number) of the user. In some embodiments, the authentication server computer 108 can be operated by an authorizing entity that operates the authorizing entity computer 120.

The mobile device 102 can have an authorizing entity application (e.g., an issuer application or banking application) which allows the mobile device 102 to interact directly with the authorizing entity computer 120. The authorizing entity application can also allow the mobile device 102 to interact directly with the authentication server computer 108.

Each of the entities in FIG. 1 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

The resource provider computer 106 may be associated with a merchant. The resource provider computer 106 may be an access device such as a POS terminal at a merchant location, a computer coupled with an access device of a merchant, or a remote server computer that operates a web site operated by the merchant. The resource provider computer 130 may be configured to generate an authorization request message for a transaction that is initiated by the user.

The transport computer 110 may be operated by an acquirer. An acquirer is typically a system for an entity (e.g., a bank) that has a business relationship with a particular merchant, a wallet provider, or another entity. The transport computer 110 may issue and manage an account of the merchant. In some embodiments, the transport computer 110 may forward the authorization request message to the processing computer 116 and the authorization response message to the resource provider computer 106 during a transaction to confirm processing of a payment transaction.

The processing computer 116 may be in a processing network such as a payment processing network. The payment processing network is configured to provide authorization services, and clearing and settlement services for payment transactions. The processing computer 116 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services.

The authorizing entity computer 120 may be operated by an authorizing entity such as an issuer. The issuer can be an entity (e.g., a bank) that issues and maintains an account of the user. The account may be a credit, debit, prepaid, or any other type of account.

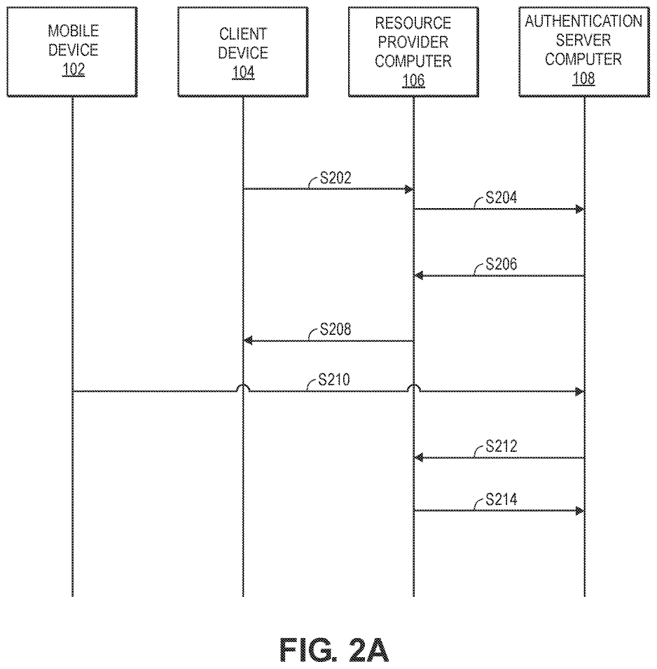

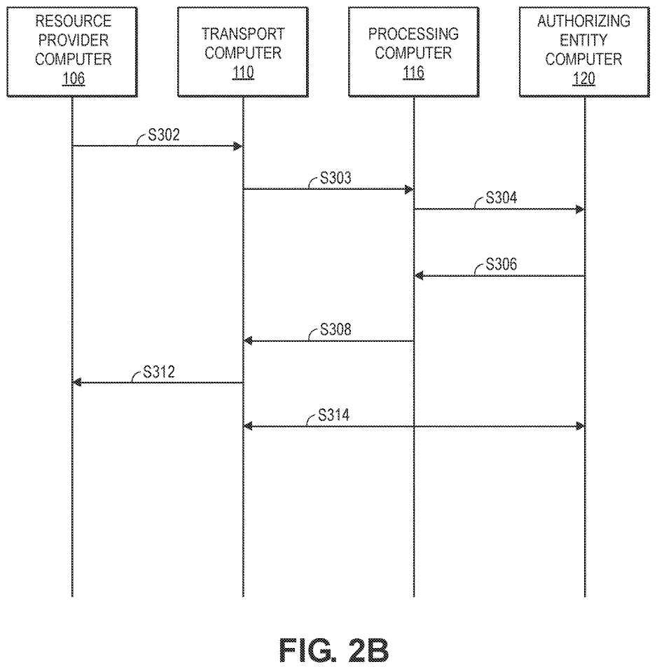

FIG. 2A shows a flow diagram of a resource provider verifying a user for a payment transaction according to embodiments. The user on a client device 104 may send a checkout request for a payment transaction for items from a resource provider operating a resource provider computer 106. The resource provider computer 106 can be in operative communication with an authentication server computer 108 to receive a one-time code that can be used to verify the user for the payment transaction. The user may use a mobile device 102 to enter the one-time code to verify user for the payment transaction. The mobile device 102 may have an application such as a banking application which can communicate with the authentication server computer 108.

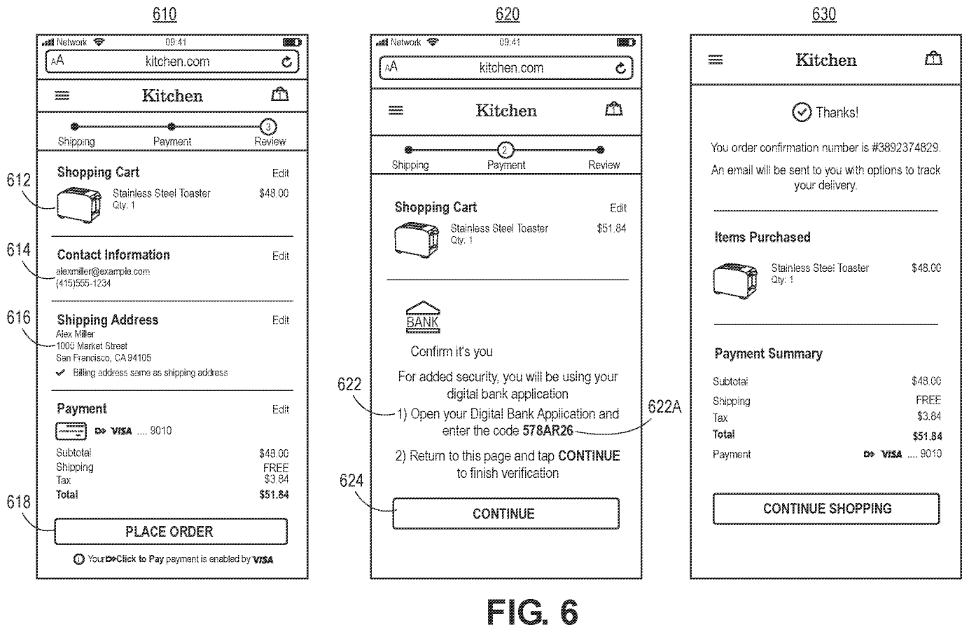

In step S202, the user on the client device 104 may be purchasing different items from on a resource provider's website running on the resource provider computer 106, and may be viewing a checkout page. An example checkout page may be displayed in screen 610 of FIG. 6. The user may use the client device 104 to send the checkout request for a transaction to the resource provider computer 106. The checkout request may contain the user's payment credential (e.g., credit card number, CVV, expiration date, etc.), item information, contact information (e.g., phone number and e-mail address, etc.). The resource provider computer 106 and the client device 104 may communicate via a first communication channel (e.g., an Internet channel, an application channel, etc.).

In step S204, upon receiving the checkout request, the resource provider computer 106 can send a one-time code request message to the authentication server computer 108 for a one-time code to verify the user for the payment transaction. The one-time code request may comprise the user's payment credential, the user's contact information, or other information associated with the user. In some embodiments, the user's payment credential (e.g., a primary account number) may be sent to the authentication server computer 108. If the authentication server computer 108 is operated by an authorizing entity such as an issuer of the user's credential, then the authentication server computer 108 can look up the user's corresponding information (e.g., phone number) associated with the credential.

In step S206, the authentication server computer 108 can generate a first one-time code and send (e.g., transmit) the first one-time code back to the resource provider computer 106 in a one-time code response message. As noted above, in some embodiments, the first one-time code generated by the authentication server computer 108 may be linked with the user's payment credential. The authentication server computer 108 can store the first one-time code in a database or memory along with the credential, the contact information for the mobile device, and a timestamp of the time when the first one-time code was generated.

In step S208, upon obtaining the first one-time code from the authentication server computer 108, the resource provider computer 106 can display the first one-time code to the user on the client device 104. The first one-time code can be displayed through a verification page of the resource provider's website or application. An example verification page may be displayed in screen 620 of FIG. 6.

In step S210, upon obtaining the first one-time code using the verification page, the user enters a second one-time code into the mobile device 102. The mobile device 102 can then transmit a verification request message comprising the second one-time code and a device address (or other device identifying information) to the authentication server computer 108 through the second communication channel that is different from the first communication channel described above. The second communication channel may include a text message channel, an e-mail channel, or a channel established by a mobile application (e.g., an issuer application). For example, the user can open an application (e.g., banking application) on the mobile device 102, which is in communication with the authentication server computer 108, and may enter the second one-time code. If the user is legitimate, then the second one-time code is the same as the first one-time code. In some embodiments, the client device 104 can include the mobile device 102, and the user can use the client device 104 to transmit the second one-time code to the authentication server computer 108.

In step S212, after receiving the verification request message, the authentication server computer 108 can compare the first one-time code that was previously sent to the resource provider computer 106 and the second one-time code that was received from the mobile device 102 to determine if they match. The authentication server computer 108 can also check to see if the time when the verification request message was received by the authentication server computer 108 is within a predetermined threshold of when the first one-time code was generated. The authentication server computer 108 can further check to see if the verification request message is coming from a previously registered mobile device. If the first one-time code and the second one-time code match, and if the other criteria above are satisfied, then then the authentication server computer 108 can then send an indication that the first one-time code matches the second one-time code. The indication can be a string of characters which indicates a match (e.g., “cc1234MATCH”). If the first one-time code does not match with the second one-time code, then the payment transaction can be rejected.

In step S214, the resource provider computer 106 can allow the payment transaction to continue based on the indication of the determination that the first one-time code matches the second one-time code. If the first one-time code matches with the second one-time code, then the payment transaction can continue. A confirmation page can be displayed to the user. An example confirmation page similar to screen 630 of FIG. 6 can be displayed to the user.

In some embodiments, when verifying the payment, the resource provider computer 106 or the authentication server computer 108 can perform an additional verification by capturing location information of the mobile device 102 and the client device 104 (e.g., via IP address in the website URL). In step S204, when the client device 104 sends the checkout request for the payment transaction to the resource provider computer 106, the resource provider computer 106 can capture the location of the client device 104. The resource provider computer 106 can send the location information to the authentication server computer 108. The authentication server computer 108 can then send a confirmation request message to the mobile device 102 that the client device 104 is attempting to perform the payment transaction at the location captured by the resource provider computer 106. The user of the mobile device 102 can confirm the confirmation request message to continue the payment transaction.

In some other embodiments, in step S210, when the mobile device 102 sends the second one-time code via an application, the authentication server computer 108 can capture the location information of the mobile device 102. In step S212, the authentication server computer 108 can compare the location information of the mobile device 102 and the client device 104, and use this information to verify the user. If the two locations different by a large amount (e.g., 100 miles or more), then the transaction may be fraudulent.

FIG. 2B shows a flow diagram of a resource provider processing a transaction according to embodiments (e.g., after step S214 in FIG. 2A).

In step S302, the resource provider computer 106 can generate an authorization request message comprising a transaction amount and a credential such as a primary account number, or a payment token. The resource provider computer 106 can then transmit the authorization request message to the transport computer 110.

In step S303, after the transport computer 110 receives the authorization request message, the transport computer 110 can forward it to the processing computer 116.

In step S304, after receiving the authorization request message, the processing computer 116 can transmit the authorization request message to the authorizing entity computer 120.

After the authorizing entity computer 120 receives the authorization request message, it can make a determination as to whether or not the transaction is authorized. It can determine if the account associated with the credential or token has sufficient funds for the transaction. It can also determine if the transaction is potentially fraudulent by analyzing data elements of the authorization request.

In step S306, the authorizing entity computer 120 can then generate an authorization response message. The authorizing entity computer 120 can then transmit it to the processing computer 116.

In step S308, the processing computer 116 can transmit the authorization response message to the transport computer 110.

In step S312, the transport computer can transmit the authorization response message to the resource provider computer 106.

In step S314, a clearing and settlement process can occur between the transport computer 110, the processing computer 116, and the authorizing entity computer 120.

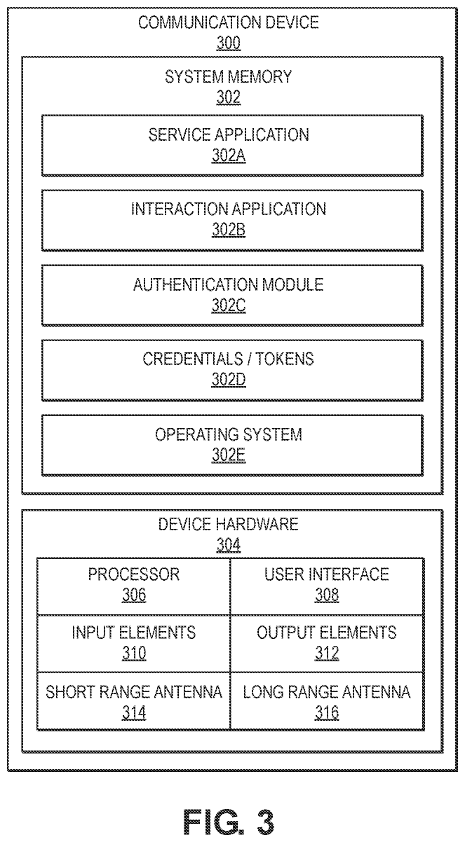

FIG. 3 illustrates a communication device 300 according to an embodiment. Communication device 300 may include device hardware 304 coupled to a system memory 302. The communication device 300 can be an example of the mobile device 102 and/or the client device 104 in FIG. 1.

Device hardware 304 may include a processor 306, a short range antenna 314, a long range antenna 316, input elements 310, a user interface 308, and output elements 312 (which may be part of the user interface 308). Examples of input elements may include microphones, keypads, touchscreens, sensors, etc. Examples of output elements may include speakers, display screens, and tactile devices. The processor 306 can be implemented as one or more integrated circuits (e.g., one or more single core or multicore microprocessors and/or microcontrollers), and is used to control the operation of mobile communication device 300. The processor 306 can execute a variety of programs in response to program code or computer-readable code stored in the system memory 302, and can maintain multiple concurrently executing programs or processes.

The long range antenna 316 may include one or more RF transceivers and/or connectors that can be used by mobile communication device 300 to communicate with other devices and/or to connect with external networks. The user interface 308 can include any combination of input and output elements to allow a user to interact with and invoke the functionalities of mobile communication device 300. The short range antenna 314 may be configured to communicate with external entities through a short range communication medium (e.g., using Bluetooth, Wi-Fi, infrared, NFC, etc.). The long range antenna 316 may be configured to communicate with a remote base station and a remote cellular or data network, over the air.

The system memory 302 can be implemented using any combination of any number of non-volatile memories (e.g., flash memory) and volatile memories (e.g., DRAM, SRAM), or any other non-transitory storage medium, or a combination thereof media. The system memory 302 may store computer code, executable by the processor 805, for performing any of the functions described herein.

The system memory 302 may also store a service application 302A (e.g., a banking application), an interaction application 302B (e.g., a merchant application), an authentication module 302C, credentials/tokens 302D, and an operating system 302E, The service application 302A may be a banking application, data access application, or the like. It can include instructions or code for causing the processor 306 to communicate with external computers such as an authentication server computer, authorizing entity computer, etc. The interaction application 302B may include code, executable by the processor 306, for communicating with a resource provider computer. The authentication module 302C may comprise code, executable by the processor 306, to authenticate a user. This can be performed using user secrets (e.g., passwords) or user biometrics.

System memory 302 may also store credentials and/or tokens 302D. Credentials may also include information identifying the mobile communication device 300 and/or the user of the mobile communication device 300.

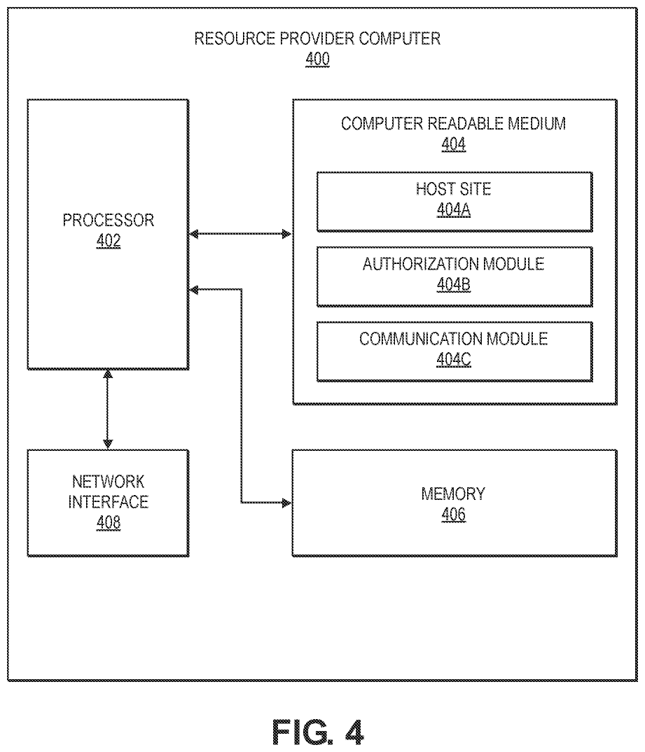

FIG. 4 shows a block diagram of a resource provider computer 400. The resource provider computer 400 includes a processor 402 and a computer readable medium 404 and a network interface 408 coupled to the processor 402.

The computer readable medium 404 may comprise a host site 404A, an authorization module 404B, and a communication module 404C.

The computer readable medium 404 may also comprise code executable by the processor 402 for performing a method comprising: receiving, from a client device, a checkout request for a transaction between a user operating the client device and a resource provider operating the resource provider computer, the resource provider computer and the client device communicating via a first communication channel; obtaining a first one-time code; displaying the first one-time code to the user on the client device; determining an indication that the first one-time code matches a second one-time code that was provided by the user through a second communication channel that is different than the first communication channel; and

allowing the transaction to continue based on the determination that the first one-time code matches the second one-time code.

The host site 404A can be a Website such as a merchant Website or backend software to manage an application such as an interaction application on a client device.

The authorization module 404B can comprise code to generate and transmit authorization request messages, and receive and process authorization response messages.

The communication module 404C may comprise code that causes the processor 402 to generate messages, forward messages, reformat messages, and/or otherwise communicate with other entities.

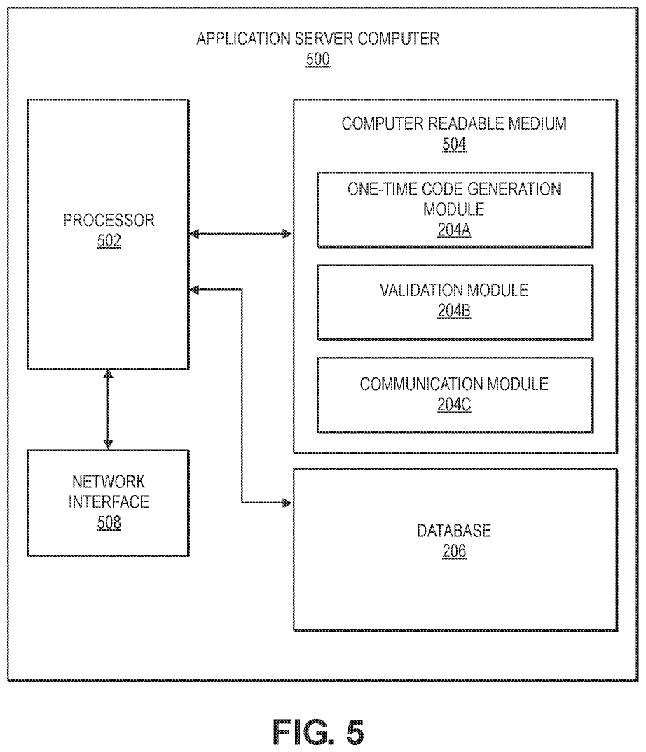

FIG. 5 shows a block diagram of an authentication server computer 500 according to an embodiment. The authentication server computer 500 may comprise a processor 502, which may be coupled to a computer readable medium 504, a database 506, and a network interface 508. The database 506 may contain mappings between one-time codes, credentials, and device identifiers and addresses.

The computer readable medium 504 may comprise a number of software modules including a one-time code generation module 504A, a validation module 504B, and a communication module 504C.

The one-time code generation module 504A and the processor 502 can generate one-time codes. It can include a random number generator or pseudo random number generator to generate random numbers that can be used to generate one-time codes.

The validation module 504B and the processor 502 can validate one-time codes that are received from external devices. The one-time code validation module can include code for comparing a generated one-time code with a received one time code, and then generate a match indicator if a match is present, or a no match indicator if a match is not present. The validation module 504B and the processor 502 can also compare locations of a client device and a mobile device to determine if they are proximate to each other.

The communication module 504C may comprise code that causes the processor 502 to generate messages, forward messages, reformat messages, and/or otherwise communicate with other entities.

The computer readable medium 504 may also comprise code, executable by the processor 502 for performing a method comprising: receiving, by an authentication server computer from a resource provider computer, a request for a one-time code, after the resource provider computer receives from a client device, a checkout request for a transaction between a user operating the client device and a resource provider operating the resource provider computer, the resource provider computer and the client device communicating via a first communication channel; generating, by the authentication server computer, a first one-time code; transmitting, by the authentication server computer, the first one-time code to the client device; receiving, by the authentication server computer, a second one-time code from a mobile device via a second communication channel; comparing, by the authentication server computer, the first one-time code to the second one-time code; and transmitting, by the authentication server computer to the resource provider computer, an indication that the first one-time code and the second one-time code match, wherein the resource provider computer thereafter allows the transaction to proceed.

FIG. 6 shows example screens shown on a client device during a verification of a payment transaction according to embodiments. The client device may be in operative communication with a resource provider to verify the payment transaction. A screen 610 may show a checkout page, a screen 620 may show a verification page, and a screen 630 may show a confirmation page.

The client device can launch the checkout page screen 610. The checkout page screen 610 may be launched after a user shopped for items from a resource provider and want to check out the items for a payment transaction. The checkout page screen 610 may comprise item information 612, contact information 614, shipping information 616, and a payment credential. Upon reviewing the information from the checkout page screen 610, the user can decide to perform the payment transaction by choosing the place order button 618.

The client device can launch the verification page screen 620. The verification page screen 620 may be launched after the user chose to perform the payment transaction (via clicking the place order button 618 of screen 610). The resource provider computer, to verify that the user is not a fraudster, may have some instructions 622 that the user can follow such that the resource provider computer (or a server computer in communication with the resource provider computer) can verify the user. As mentioned in FIG. 1, the verification page can display a one-time code 622A that the resource provider computer received from a server computer. The user can follow the instruction 622, and upon completing the instruction, can continue by clicking a continue button 624.

The client device can launch the confirmation page screen 630. The confirmation page screen 630 may be launched if the verification has been successfully processed by the resource provider computer to continue with the payment transaction. The confirmation page screen 630 may comprise item information 632 and payment summary 634. The payment summary 634 may comprise subtotal, tax information, shipping information, total payment information, payment credential information, etc.

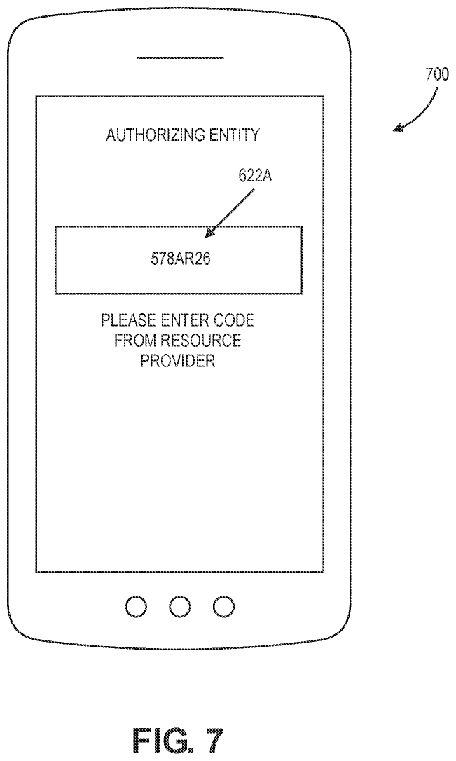

FIG. 7 shows an example screen on a mobile device in which a user can enter a one-time code such as the one-time code 622A in FIG. 6. Once the user enters the one-time code 622A, the one-time code 622A is transmitted to the authentication server computer as described above. The authentication server computer can generate a match indication if a match is present, and can send the match indication to the resource provider computer. The resource provider computer can then proceed with the interaction since the user was authenticated.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a resource provider computer from a client device, a checkout request for a transaction between a user operating the client device and a resource provider operating the resource provider computer, the resource provider computer and the client device communicating via a first communication channel;
obtaining, by the resource provider computer, a first one-time code;
displaying, by the resource provider computer, the first one-time code to the user on the client device;
determining, by the resource provider computer, an indication that the first one-time code matches a second one-time code that was provided by the user through a second communication channel that is different than the first communication channel; and
allowing, by the resource provider computer, the transaction to continue based on the determination that the first one-time code matches the second one-time code.

2. The method of claim 1, wherein the indication is received from an authentication server computer in communication with the resource provider computer, wherein the second one-time code was provided by the user to the authentication server computer through the second communication channel using a mobile device.

3. The method of claim 2, wherein the client device includes the mobile device.

4. The method of claim 2, wherein the client device is a laptop computer and the mobile device is a mobile phone.

5. The method of claim 1, further comprising:
generating, by the resource provider computer, an authorization request message; and
transmitting, by the resource provider computer, the authorization request message to an authorizing entity computer for authorization.

6. The method of claim 1, wherein the first communication channel is an Internet channel and the second communication channel is an SMS channel.

7. The method of claim 1, wherein the first one-time code is a randomly generated code.

8. The method of claim 1, wherein the client device communicates with the resource provider computer via a host site on the resource provider computer.

9. The method of claim 1, wherein obtaining, by the resource provider computer, the first one-time code comprises receiving the first one-time code from an authentication server computer.

10. The method of claim 9, wherein determining, by the resource provider computer, the indication that the first one-time code matches the second one-time code occurs after the resource provider computer receives the indication from the authentication server computer.

11. The method of claim 1, wherein obtaining, by the resource provider computer, the first one-time code comprises receiving the first one-time code from an authentication server after the user of the client device enters a credential for an account into the resource provider computer.

12. A resource provider computer comprising:
a processor; and
a non-transitory computer readable medium, the non-transitory computer readable medium comprising code, executable by the processor for implementing a method comprising:
receiving, from a client device, a checkout request for a transaction between a user operating the client device and a resource provider operating the resource provider computer, the resource provider computer and the client device communicating via a first communication channel;
obtaining a first one-time code;
displaying the first one-time code to the user on the client device;
determining an indication that the first one-time code matches a second one-time code that was provided by the user through a second communication channel that is different than the first communication channel; and
allowing the transaction to continue based on the determination that the first one-time code matches the second one-time code.

13. A method comprising:
receiving, by an authentication server computer from a resource provider computer, a request for a one-time code, after the resource provider computer receives from a client device, a checkout request for a transaction between a user operating the client device and a resource provider operating the resource provider computer, the resource provider computer and the client device communicating via a first communication channel;
generating, by the authentication server computer, a first one-time code;
transmitting, by the authentication server computer, the first one-time code to the client device;
receiving, by the authentication server computer, a second one-time code from a mobile device;
comparing, by the authentication server computer, the first one-time code to the second one-time code via a second communication channel; and
transmitting, by the authentication server computer to the resource provider computer, an indication that the first one-time code and the second one-time code match, wherein the resource provider computer thereafter allows the transaction to proceed.

14. The method of claim 13, wherein the first communication channel includes a channel using an interaction application and the second communication channel includes a channel using a service application.

15. The method of claim 14, further comprising:
determining, by the authentication server computer if a location of the mobile device and the client device match before transmitting the indication to the client device.

16. The method of claim 14, wherein the client device is a laptop computer and the mobile device is a mobile phone.

17. The method of claim 14, wherein the first one-time code is a random number.

18. The method of claim 17, wherein the authentication server computer comprises a one-time code generation module that generates the one-time code.

19. The method of claim 18, wherein the one-time code generation module comprises a random number generator.

20. The method of claim 19, wherein the authentication server computer is operated by an authorizing entity that operates an authorizing entity computer that authorizes the transaction.
